(19) United States
(12) Patent Application Publication
(10) Pub. No.: US 2011/0129396 A1
(43) Pub. Date: Jun. 2, 2011

(54) VOLUMETRIC SAMPLING PIPETTE

(75) Inventor: Falk Fish, Tel Aviv (IL)

(73) Assignee: Alere Switzerland GmbH, Zug (CH)

(21) Appl. No.: 12/790,828

(22) Filed: May 30, 2010

Related U.S. Application Data
(60) Provisional application No. 61/182,718, filed on May 31, 2009.

(51) Int. Cl. B01L 3/02

(52) U.S. Cl. 422/507

(57) ABSTRACT

A volumetric micropipette for sampling and dispensing a precise quantity of liquid comprising an elongated hollow tubular body configured to draw liquid by capillary action: a reservoir connected proximate the upper end of the tubular body and a deformable hollow bulb connected to the reservoir and having an opening in a wall thereof to allow liquid to be drawn into the tubular body by capillary action. The reservoir is laterally offset with respect to the tubular body and has at least a portion thereof below the upper end of the tubular body.

### FIELD OF THE INVENTION

The invention relates to a micropipette for collection and subsequent dispensing of a fluid, the fluid being especially blood such as obtained by a finger prick.

### BACKGROUND OF THE INVENTION

In the general profession of in vitro medical diagnosis, samples of bloods are taken and transferred to a test device, which then processes the blood and detects the presence or absence of a disease state or other physiological condition or parameter. In order to minimize discomfort of the patient and to avoid puncturing the patient's vein, some tests are designed to require small volumes of blood, such as can be obtained by pricking the skin of a fingertip with a small needle or lancet and expressing a drop of blood by slight pressure on the fingertip. The thus obtained drop of blood can then be applied directly to a test device, such as is the case of testing for the level of glucose in blood, which is carried out by diabetic patients. For some test devices, however, the volume of blood which forms a drop on the surface of the fingertip is insufficient and the exact volume must be accurately measured and delivered to a test device. When the required volume exceeds the volume of a single drop, repeated collections of blood drops are obtained by multiple repeated squeezing and each time the expressed drop is collected and added to the already obtained former drops of blood. One way for achieving this goal is by using a graduated or calibrated capillary tube to suck the blood from the surface of the fingertip by spontaneous capillary action. Such capillary tubes are obtainable for example from Drummond Scientific Company, Broomall, Pa., USA. Having collected the required volume of blood, the blood sample has to be transferred to the test device. Since the blood is held in the tube by capillary force, it has to be expelled from the capillary either by applying pressure on the liquid or by touching capillary tube to a hydrophilic bibulous surface, which in itself provides a capillary suction force. Pressure can be provided by air, using a flexible bulb, or by inserting a piston into the tube. It is clear that such operations are complicating the procedure and the passive transfer of the blood sample based on capillary suction is slow, it is interruptible by bubbles in the tube and is not always possible in case the test device does not have a suitable bibulous surface.

The above mentioned shortcomings of capillary tube are overcome in U.S. Pat. No. 5,460,782, assigned to Safe-Tec Clinical Products, Inc., Ivyland, Pa., the full content of which is incorporated herein by reference. A product based on that patent is distributed by Safe-Tee under the name MicroSafe. The Safe-Tec device is a capillary tube combined with a flexible bulb. The device is made of wettable plastic or made wettable by a variety of processes, some are detailed in the patent. The volume of sample that device can collect is determined by the distance of a small hole or vent in the capillary tube from the sample entry opening of the tube. When collecting a predetermined volume of fingerprick blood, the sample entry opening is touched to the drop of blood. The blood enters the tube by capillary force. If the collected blood is insufficient, another drop of blood is expressed and the device is touched again to the drop. The device ceases collecting the blood when the blood reaches the small hole in the capillary tube and blocks it, thus causing a contradicting air pressure build-up in the device which prevents additional capillary-force-mediated entry of blood. Transferring the thus collected sample to a test device can be accomplished quickly by pressing the bulb. While the device of U.S. Pat. No. 5,460,782 provides an appreciable improvement over a basic capillary tube it has a few shortcomings:
(a) When pressing the bulb to expel the sample, the fluid, which blocks the small hole/vent can be expelled as well. When that hole is open some of the sample can be expelled through it, thus not being delivered to the test device. This requires the user to block that hole by placing a finger over it, so that at least 3 fingers are required for that operation.
(b) The sample, which is expelled from the small hole, constitutes a danger for contaminating the environment and the user.

Therefore, it is the aim of this invention to provide an improved sampling device, intended for step-wise, capillary force mediated collection of a fluid sample and rapid active delivery to a test device. The embodiments of the invention overcome the above listed shortcomings.

### SUMMARY OF THE INVENTION

There is provided a volumetric micropipette for sampling and dispensing a precise quantity of liquid, comprising an elongated hollow tubular body configured to draw liquid by capillary action; at least one reservoir structurally connected proximate the upper end of the tubular body and in fluid communication therewith by means of a first fluid conduit, and a deformable hollow bulb structurally connected to the at least one reservoir and in fluid communication therewith by means of a second fluid conduit. The deformable hollow bulb is having an opening in a wall thereof to allow liquid to be drawn into the tubular body by capillary action when the lower open end of the tubular body is brought in contact with said liquid. The least one reservoir is laterally offset with respect to the tubular body and is having at least a portion thereof below the upper end of the tubular body. The tubular body is having a wettable interior surface and an inner diameter sized to permit liquid to flow into the tubular body by capillary action. Preferably the opening in the bulb is having a diameter of about 1 mm.

The micropipette may be comprised of a wettable plastic, a glass, a metal, a ceramic or a combination thereof. The tubular body may be fabricated from a wettable thermoplastic selected from the group of thermoplastics consisting of acrylonitrile barrier resins, polyether block polyamides, cellulose acetate propionate, and butyrate or any polymer which has been treated in a manner to render the polymer wettable. The tubular body may have an interior surface which has been treated to render the interior surface wettable.

### BRIEF DESCRIPTION OF THE DRAWINGS

FIGS. 1A and 1B are perspective view and a side view, respectively, of an embodiment of a volumetric pipette of the invention, corresponding to the pipette illustrated in FIGS. 8 and 9 of U.S. Pat. No. 4,779,768.

### DETAILED DESCRIPTION OF THE INVENTION

U.S. Pat. No. 4,779,768, “Volumetric dispensing pipette”, the full content of which is incorporated herein by reference, discloses an exact volume transfer pipette, which is marketed by Poly-Pipets. Inc., Englewood Cliffs, N.J., USA. FIGS. 8 and 9 in U.S. Pat. No. 4,779,768 most closely depict the product which is currently marketed by Poly-Pipets, Inc. The use of the U.S. Pat. No. 4,779,768 pipette is limited to active drawing of fluid from a liquid source or reservoir by squeezing a deformable bulb and to dispensing/expelling a defined volume of that liquid when pressing the deformable bulb. Any excess fluid, which was inadvertently drawn in, is not expelled since it is held in a fluid reservoir, henceforth termed: “trap”, which is positioned between the tube, into which the fluid is being drawn, and the deformable bulb. Thus, the U.S. Pat. No. 4,779,768 device can be used only when the readily available volume of the fluid source is at least equal to the desired dispense volume. Therefore, that pipette cannot be used to directly collect a defined volume of blood from a fingerprick, since when drawing in partial volumes (volumes which are smaller than the volume of the fluid collection and delivery tubular section of the pipette) air bubbles are formed between the partial volumes so that the dispensed volume is smaller than the required one.

The aim of this invention is to modify and improve the pipette disclosed in U.S. Pat. No. 4,779,768 so that the pipette can be used to repeatedly collect fractional volumes of fluid (e.g. blood) from a surface (e.g. finger skin) and dispense the collected fluid in a single operation with accurate volume. The improvement does not degrade the original intended functionality of the U.S. Pat. No. 4,779,768 pipette, so that the utility of the pipette is expanded and can be employed by a larger customer base.

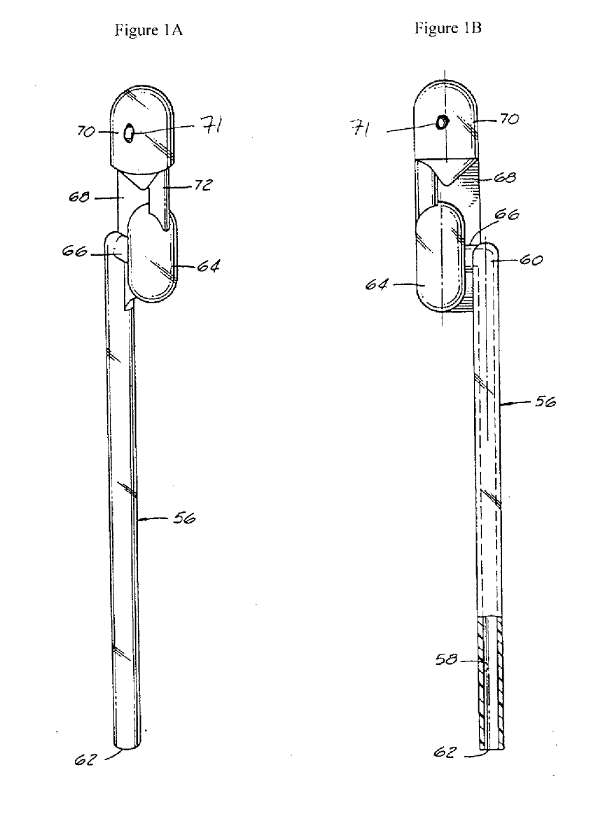

The basic additional embodiment is a hole in the “deformable hollow bulb” and it is depicted in FIGS. 1 (item 71 in FIGS. 1). The hole should be preferably located on the side of that bulb and should be sized so as to be completely and easily coverable by a finger, holding said bulb. The diameter of said hole is preferably 1 mm, but can be of any size smaller than the surface of a finger and sufficiently large so that air can flow through the hole.

When holding the pipette with the bulb (70), so that the hole (71) is covered with the finger, the pipette can be used as originally intended for actively drawing liquid by first squeezing the bulb, then placing its open end (62) in the liquid. Alternatively, when holding the pipette at any other location of its structure, or even holding it with the bulb but so as not covering the hole, the pipette can be used to collect and combine small fractions of liquid by touching the open end (62) with the liquid, thereby liquid is drawn into the tube (56), similarly to the pipette of the aforementioned U.S. Pat. No. 5,460,782, providing the surface of the tube is wettable. In order to dispense the collected fluid from the pipette, the user simply presses the bulb, ensuring that the hole is covered with one of the user's fingers. In case the hole is not covered during the dispense step, it will be immediately made clear to the user since no fluid will be expelled.

By providing a hole in the bulb of a pipette which is having a structure as taught by U.S. Pat. No. 4,779,768, the aforementioned shortcomings of U.S. Pat. No. 5,460,782 are overcome:
(a) The hole is now located away from the fluid path, especially if the volume of the “trap” is larger than that of the squeeze bulb. So, the danger of fluid being touched or being forced out of a hole is eliminated or greatly minimized.
(b) Only 2 fingers are required to operate the pipette and none touches the fluid sample.

It will be realized that although FIG. 1 depict a specific embodiment of the present invention which corresponds to the pipette depicted in FIGS. 8 and 9 of U.S. Pat. No. 4,779,768, the invention is not limited to that specific embodiment, but rather, the present invention may be applied to any of the pipettes depicted in FIGS. 1 through 7 of U.S. Pat. No. 4,779,768, as well as to and any other designs incorporating the invention of U.S. Pat. No. 4,779,768, by adding an aperture in the squeezable bulb.

As mentioned above, for the operation of collecting and combining fractional volumes of fluid the surface of at least the “hollow tube” must be wettable. U.S. Pat. No. 5,460,782 lists multiple ways of imparting wettability to plastic surfaces, including fabricating the pipette from inherently wettable plastic resins and gas plasma treatment of other plastic resins. Additional processes can be considered for this goal:
1. Corona discharge
2. Flame treatment
3. Coating of the tube with detergent or surfactant, preferably either are non-hemolytic
4. Coating of the tube with protein.

1. A volumetric micropipette for sampling and dispensing a precise quantity of liquid, the volumetric micropipette comprising:
an elongated hollow tubular body configured to draw liquid by capillary action, the hollow tubular body is having a lower open end and an upper end;
at least one reservoir structurally connected proximate the upper end of the tubular body and in fluid communication therewith by means of a first fluid conduit, wherein said at least one reservoir is laterally offset with respect to the tubular body and is having at least a portion thereof below the upper end of the tubular body; and
a deformable hollow bulb structurally connected to said at least one reservoir and in fluid communication therewith by means of a second fluid conduit, wherein said deformable hollow bulb is having an opening in a wall thereof to allow liquid to be drawn into the tubular body by capillary action when the lower open end of the tubular body is brought in contact with said liquid.

2. A volumetric micropipette as defined in claim 1 wherein said tubular body is having an inner diameter sized to permit liquid to flow into the tubular body by capillary action.

3. A volumetric micropipette as defined in claim 1 in which at least the interior surface of said tubular body is wettable.

4. A volumetric micropipette as defined in claim 1 wherein said opening is located on a side wall of said bulb.

5. A volumetric micropipette as defined in claim 1 wherein said opening is having a diameter of about 1 mm.

6. A volumetric micropipette as defined in claim 1 wherein the tubular body is fabricated from a wettable thermoplastic.

7. A volumetric micropipette as defined in claim 6 wherein the wettable thermoplastic is selected from the group of thermoplastics consisting of acrylonitrile barrier resins, polyether block polyamides, cellulose acetate propionate, and butyrate.

8. A volumetric micropipette as defined in claim 1 wherein the micropipette is comprised of a wettable plastic, a glass, a metal, a ceramic or a combination thereof.

9. A volumetric micropipette as defined in claim 1 wherein the tubular body is made of a polymer which has been treated in a manner to render the polymer wettable.

10. A volumetric micropipette as defined in claim 1 wherein the tubular body has an interior surface which has been treated to render the interior surface wettable.
